(19) United States
(12) Patent Application Publication
(10) Pub. No.: US 2013/0246432 A1
(43) Pub. Date: Sep. 19, 2013

(54) PROVIDING CONTENT BASED ON ONLINE TOPICAL TRENDS

(71) Applicants: Ronnie PASKIN, Fort Lauderdale, FL (US); George GLEADALL, Boca Raton, FL (US); Shawn STEWART, Plantation, FL (US)

(72) Inventors: Ronnie PASKIN, Fort Lauderdale, FL (US); George GLEADALL, Boca Raton, FL (US); Shawn STEWART, Plantation, FL (US)

(21) Appl. No.: 13/421,480

(22) Filed: Mar. 15, 2012

(51) Int. Cl. G06F 17/30

(52) U.S. Cl. 707/740; 707/E17.092

(57) ABSTRACT

One or more criteria are determined for a trending topic. A search is performed to determine content items that satisfy the one or more criteria. Portions of at least some of the content items are provided in, or made accessible from, a medium that is specific to a subject category that is based on the one or more criteria.

### TECHNICAL FIELD

Embodiments described herein pertain to providing online content, and more specifically, to a system and method for providing content based on online topical trends.

### BACKGROUND

The online properties of content providers can accumulate over time. For example, web pages, news items and other forms of content tend to accumulate as new content is created. Generally, content items tend to lose interest to the population of users over time.

### BRIEF DESCRIPTION OF THE DRAWINGS

FIG. 1 illustrates a system for providing content based on topical trends that are identified from user-generated online communications, according to an embodiment.

FIG. 2A illustrates a method for providing content that is based on topics that are trending in the context of online communications amongst the population of persons, under an embodiment.

FIG. 2B illustrates a method for performing multiple search operations in connection with the identification of a particular topical trend, in order to determine category specific content that is trending in popularity or notoriety, under one or more embodiments.

FIG. 3 illustrates an example of a panel presentation for displaying content based on topical trends, according to one or more embodiments.

FIG. 4 is a block diagram that illustrates a computer system upon which embodiments described herein may be implemented.

### DETAILED DESCRIPTION

Embodiments described herein identify and provide content, such as articles and web-content, for categories of subject matter that correlate to topics that are deemed to be trending in online communications originating from a population of persons.

In an embodiment, one or more criteria are determined for a trending topic. A search is performed to determine content items that satisfy the one or more criteria. Portions of at least some of the content items are provided in, or made accessible from, a medium that is specific to a subject category that is based on the one or more criteria.

According to embodiments, the use of online communications can include the mentioning of a specific topic (e.g., person, event, product name, television series, etc.) in forums such as provided by TWITTER (e.g., number of “tweets” that mention a particular person over the course of an hour or day), posts in FACEBOOK, “check-ins” in FOURSQUARE, as well as live chats or other online conversations in other mediums.

According to embodiments, the determination as to what topics are trending is made in real-time. For example, the number of times a particular topic is mentioned in a time period, such as an hour (or day), can be monitored in determining the topic as being “hot” amongst a population. Furthermore, the determination of content items that correlate to the identified topic, as well as the presentation of content on the category specific medium can be performed in real-time. For example, once one or more criteria for a trending topic are identified, multiple searches can be performed using the determined criteria in order to maintain freshness in the determined content items.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

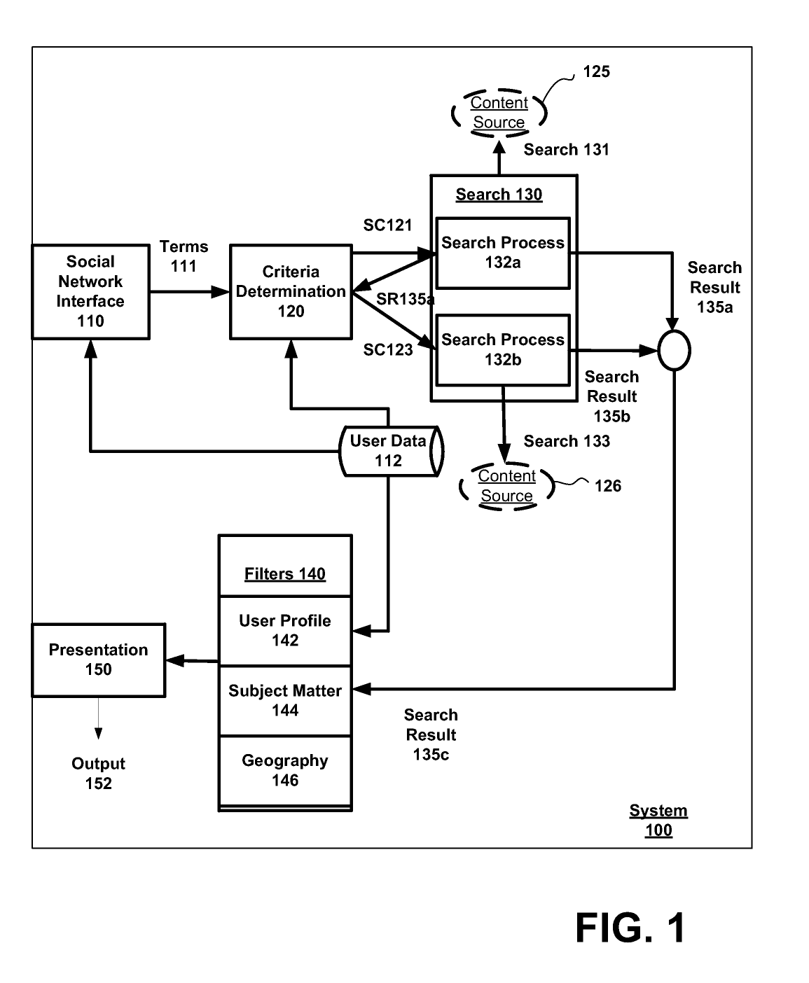

FIG. 1 illustrates a system for providing content based on topical trends that are identified from user-generated online communications, according to an embodiment. More specifically, FIG. 1 illustrates a system for providing content that is based on topics that are trending in the context of online communications amongst a population of persons. A system such as described can be implemented in various contexts.

In an embodiment, system 100 includes a social network interface 110, a criteria determination component 120, one or more search components 130, one or more filters 140, and a presentation component 150. In operation, the components of system 100 may be implemented on the network side resources (e.g., a server or combination thereof). In one implementation, system 100 is provided as a service, operable to communicate with client terminals in order to provide content that are relevant to topics that are tending at a given instances of time. Accordingly, system 100 can be implemented by one or more servers, or through other computer systems in alternative architectures (e.g., peer-to-peer networks, etc.). In alternative implementations, some or all of the components of system 100 can be implemented on client machines, such as through applications that operate on user terminals. For example, a client application may execute to perform the processes described by the various components of system 100.

The social network interface 110 provides an example of a component that can analyze or review public or semi-public online communications for the mentioning of specific topics. For example, social network interface 110 can operate to determine terms that are trending or heavily mentioned in tweets on the social network TWITTER. For example, the social network interface 110 can monitor postings and other social network environments, such as FACEBOOK. In variations, alternative forms of online communications can be analyzed or monitored in order to determine trending topics. For example, commentary from users at log sites can be used to determine a topic that is trending in terms of user-generated online communications.

A term that is trending in popularity can correspond to a word (e.g., proper noun, such as a name of a person) or phrase that is deemed heavily in use in a given period of time. Certain caveats or conditions may be provided in connection with deeming a heavily used term to be trending. For example, implementations may provide for a heavily used term or phrase to be trending based on a category of the term, or based on historical counts of the use of the term. In variations, a term can be deemed trending based on a percentage increase of the use of the term in user-generated online communications relative to a baseline. Thus, in some instances, a term may be deemed trending in a given time period even if that term is not one of the most heavily used terms of that time period.

According to an embodiment, social network interface 110 communicates with a service of a social network in order to obtain trending terms 111 that are heavily in use by a population at a particular time. The identification of such terms can be done while maintaining user privacy or anonymity. For example, the social network interface 110 can access the programmatic interface of a social network, or utilize a third-party service, in order to determine trending terms or phrases. In other implementations, the interface 110 processes certain forms of social networking communications in order to determine trending terms or phrases. Thus, in such variations, the interface 110 can make its own determination as to trending terms by monitoring comments, postings, or online communications amongst a population of users.

Optionally, the criteria determination component 120 processes trending terms 111 to determine one or more corresponding search criterion 121 for use in searching content sources. In an embodiment, the criteria determination component 120 generates semantic variations or equivalents to a trending term. In one implementation, the search criteria 121 includes a set of multiple search terms that are based on, or are otherwise determined from a trending term 111. For example, a term 111 of “Obama” can result in a set of search terms that includes “President,” “President Obama,” and “Barack Obama.” In some variations, more intelligent associations may be made between a given term 111 and a criterion. For example, the term “Obama” may also generate the criteria “Democratic Presidents.”

The one or more search components 130 perform searches based on the search criteria 121. Multiple sources of content may be searched based on the search criteria 121. Embodiments recognize that using search criteria that is generated from a trending topic (e.g., as determined from social network communications) inherently produces content items of interest. Thus, for example, a trending term may have an inherent association with a particular subject category (e.g., “sports” or “golf”), but the aggregation of content items can span multiple categories, including categories that are not the predominant association for the term. As such, one or more embodiments provide for the search component 130 to perform searches and aggregate content items from across multiple subject categories. This can result in aggregation of content items that are not just recent, but highly relevant to the search criteria. As a result, content items that would otherwise not be exposed to the public can be aggregated for public viewing at a time when those content items are more likely to be of interest. For example, if the topical trend is identified “Tiger Woods,” embodiments recognize that content items pertaining to Tiger Woods are of interest to the public, regardless of whether, for example, the content items pertain to “golf”. Thus, the search may identify content items dealing with Tiger Woods in fashion or gaming, with instances in which such content items are not necessarily recent as compared to the current event that made Tiger Wood the topical trend.

According to embodiments, the search component 130 includes multiple search processes 132a, 132b to provide search results 135a, 135b. Multiple search processes 132a, 132b can be performed in order to identify search results that are diverse and complimentary. In an embodiment, a first search process 132a uses search criteria 121 to perform a first search 131 on a first source of content items 125. For example, the first source of content items 125 can correspond to an indexed library of web pages. The second search process 132b performs a second search 133 on a second source of content items 126. For example, the second source of content items 126 can correspond to an indexed library of web resources, including content such as documents, media files (e.g., images or video), or user generated content. In an embodiment, the result 135b of the second search process 132b is used to augment or enhance the result 135a of the first search process 132a. For example, the first search process 132a can search (or alternatively, utilize a first search engine) a corresponding indexed collection of web pages based on the search criteria 121. The second search process 132b can search (or utilize a second search engine) a second collection of web resources (e.g., images, video, etc.). In this way, the first and second collection of content items provide content from different sources.

While the first search process 132a may utilize the search criteria 121 (as determined from the topic input 111), an embodiment provides that the second search process 132b uses a derived search criteria other than that which was used for the first search process 132a. In an embodiment, the second search process 132b may utilize data identified from the first search result 135a in order to determine a criterion 123 for performing the second search process 132b. For example, the first search result 135a may return documents that include tags. The tags can be processed by, for example, the criteria determination component 120 in order to generate the second criterion 123 for the second search process 132b. Thus, the tags supplied with, for example, the documents of the first search process 132a may be used to determine the second criterion 123 for the second search process 132b.

According to embodiments, additional search processes may be performed based on the original search criteria 121, and/or subsequently determined search criteria 123.

Additionally, the second search process 132b can be used to identify web resources that are of a different type than those identified from the first search process 132a. In one embodiment, the first search result 135a (returned from the first search process 132a) is used to identify articles, documents, postings and other content items that are of a particular type (e.g., text based content). The second search process 132b (or additional searches) can be used to identify other forms of content (e.g., images, media) that are relevant to the results 135a.

Additionally, in variations, each search process 132a, 132b can execute an algorithm to identify content items based on factors such as relevancy to the search criteria and/or recency. In some embodiments, the algorithms used by each search process 132a, 132b can be different. For example, different search engines may be utilized by each search process. As an alternative, each search process 132a, 132b may execute a different relevancy algorithm.

A search result 135c can correspond to a combination of search results 135a, 135b (in embodiments where multiple search processes are performed). Accordingly, the search result 135c can identify, or comprise content items identified from search process 132a and search process 132b. More specifically, search result 135c can correspond to the search results 135a, 135b of search processes 132a, 132b that are performed for criteria that includes criterion determined from topical input 111. In this way, the search results 135a, 135b can relate to a common subject category.

In some embodiments, search result 135c can be filtered for a particular user or set of users so as to increase the relevancy of the search result to a user or class of users. In an embodiment, a filter 140 can include one or more components that select or de-select content items from the search result 135c.

In an embodiment, a user profile filter 142 accesses a user data store 112 in order to filter or otherwise select content items from the search result 135c for a particular user. The user data store 112 can be implemented in a variety of ways. In one implementation, the user data store 112 is a set of cookie data, provided by, for example, tracking cookies installed on a user's client machine. In variations, system 100 may have made a service that enables individual users to login or otherwise identify themselves (e.g., anonymously, by moniker) to the service. The user data store 112 can include information such as preferences of the user for a particular type of content (e.g., sports or celebrity news). The user profile filter 142 can select content items from the search result 135c based on data that would indicate a user interest for a particular subject matter, or alternatively, a user disinterest for the subject matter.

As an addition or alternative, a subject matter filter 144 may be implemented to select or exclude content items from the search result 135c which are, for example, associated with tags, metadata or content that is of a subject matter that is not deemed to be relevant or sufficiently of interest to a user or a class of users. For example, if the trending topic of “Tiger Woods” results in content items that include web pages tagged with clothing modeled by Tiger Woods, the subject matter filter 144 may exclude those web pages as not being relevant, given the class of users that are targeted being golf fans.

As another addition or alternative, a geographic filter 146 can be implemented to select or exclude content items based on specific geographic zones or regions. For example, the content items included in the search result 135c, which are associated with metadata, tags, or content, can include content specifying or relating to a geographic region that is not relevant to a particular set of users in a given locality (e.g., city, state, country, etc.). The geographic filter 146 can filter out or exclude such content items.

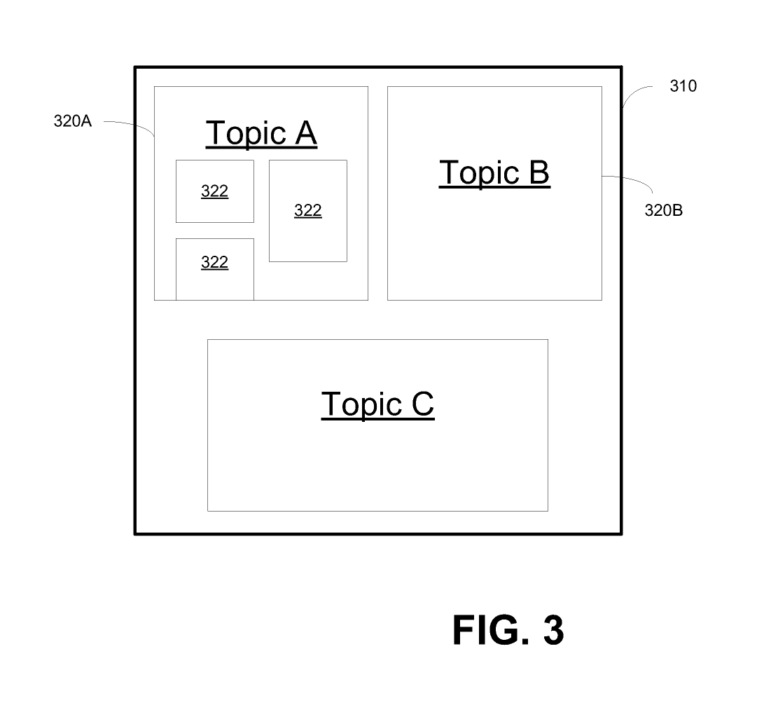

According to an embodiment, presentation component 150 generates an output presentation 152 that is specific to a category of the search criteria 121 (or to the topic of the trending term 111). The output presentation 152 can have a variety of forms. For example, the output presentation 152 can correspond to a webpage (or portion thereof) that is populated with portions of the content items identified in the search results 135a, 135b. In variations, the output presentation 152 can be in the form of an electronic magazine about a subject corresponding to the topic of the trending term 111. Furthermore, in variations such as described by an embodiment of FIG. 3, the output presentation 152 can be provided as a feed that outputs portions of the content items identified through the one or more search processes 132a, 132b.

For example, the output presentation 152 can be generated for a graphic panel that can be selected and “flipped” through. In such an implementation, some of the content items that are generated as part of the search process 132a, 132b can be presented sequentially. For example, a portion of one content item may be presented in the panel, and the user may then flip to another panel that displays a portion of a second content item. Furthermore, the panel at a first instance of time can concurrently display a portion of a content item from the first search processes 132a, and a content item (e.g., image) from the second search process 132b. The user can manipulate the graphic panel to select a next panel in which a next content item from each of the first and second search processes 132a, 132b can be displayed concurrently.

In variations, the user data store 112 and/or user profile filter 142 can be used to influence or otherwise configure the performance of multiple components that comprise system 100. For example, the user data store 112 can be used to select which (if any) trending topics are to be used as the basis for the formulation of search criteria. For example, data from the user data store 112 may indicate a sports fan, in which case the trending topics relating to sports may be selected for use for system 100. Such an embodiment may be implemented in the context of providing content items that are deemed relevant to a specific user. Similarly, data from the user data store 112 can be used to configure one or more search processes 132a, 132b of the search component 130. For example, user profile data from the user data store 112 may indicate user interest in “golf” so that a trending topic input 111 corresponding to “Tiger Woods” includes golf in the search criteria 121. This can result in a search result 135a, 135b that is more relevant to subject matter that is of interest to a particular user.

Similarly, one or more embodiments provide for other components of filter 140 to be implemented to configure alternative operations of system 100. For example, the social network interface 110 can be configured by components of filter 140 in order to select or exclude certain trending topics. For example, the geographic filter 146 can be used to select, for a particular context, trending topics that are geographically relevant. Likewise, the subject matter filter 144 can be used, for example, to exclude trending topics that are deemed not of interest to a particular class of users (e.g., news on movie celebrities excluded for golf fans).

Methodology

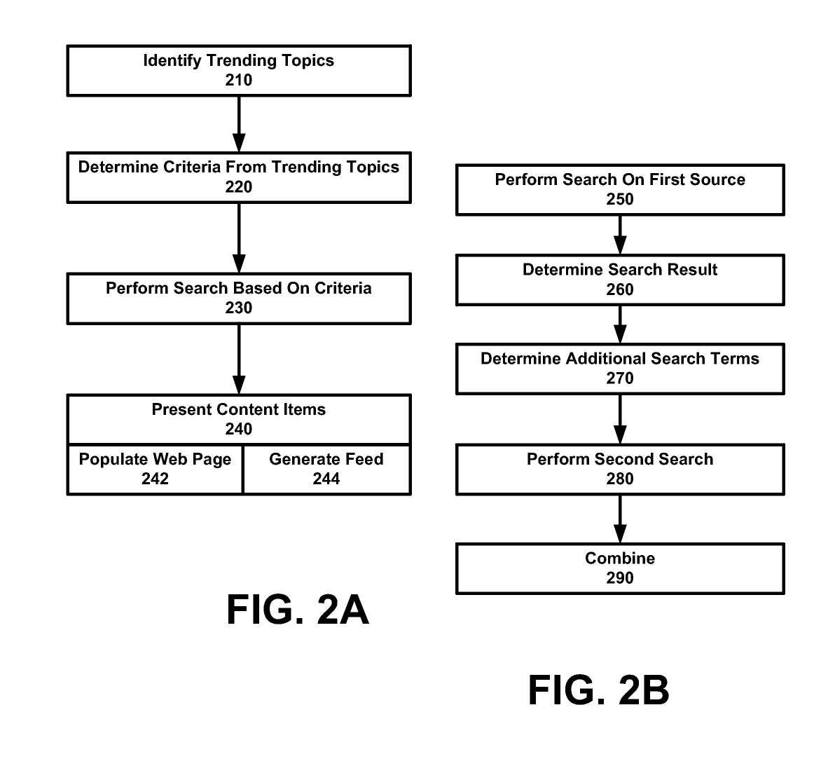

FIG. 2A illustrates a method for providing content that is based on topics that are trending in the context of online communications amongst the population of persons. A method such as described by an embodiment of FIG. 2A may be implemented using a system such as described with an embodiment of FIG. 1. Accordingly, reference may be made to elements of system 100 for purpose of illustrating a suitable component for performing a step or sub-step being described.

According to an embodiment, one or more topics are identified as trending based on instances of such topics being mentioned in online communications amongst the population of users (210). As mentioned with other embodiments, various sources can be analyzed or otherwise use in order to identify topics that are trending. Among them, social networks such as provided by TWITTER or FACEBOOK can be utilized to identify terms that trend up in their respective prevalence amongst postings, conversations, commentary and/or other forms of user-generated communications. In variations, commentary provided on webpages such as blogs, online communication forms, and other sources of user generated conversations and communications can be monitored, analyze, or otherwise used in order to identify trending topics.

According to one or more embodiments, a term or phrase may be deemed to be trending if the term or phrase is associated with the topic and of a class that is most frequently mentioned over the course of the designated duration of time (e.g., an hour, a day, a week, etc.). Examples of terms or phrases that may be trending include, for example, include proper noun signifying the name of a person (e.g., celebrity, singer, artist, athlete, etc.), the name of an entertainment program, the name of a product, a reference to a particular activity, a historical reference, or a movie title.

In variations, terms or phrases may be deemed trending if they satisfy additional criteria, such as whether the terms or phrases pertain to a subject matter of a particular category. Still further, terms or phrases may be deemed trending based on the number of instances that such terms or phrases are utilized in online communications as compared to baseline for that term or phrase. Thus, for example, a trending celebrity name may not necessarily be the most prevailing celebrity name in an online communication forum.

In some embodiments, the trending topics are determined by a third-party service. Thus, for example, a social network interface 110 may obtain terms or phrases for trending topics from a third-party service.

According to embodiments, the presentation of the content items can be filtered, or otherwise made selected for a specific user or audience. In one embodiment, information about a particular user is used to topical trend is processed for search terms and results. For example, a list of topical trends may include references to different celebrities or athletes. For a particular user, information known about the user (e.g., see data store 112) can be used to for searching and presentation.

In an embodiment, one or more search terms are determined from a trending topic (220). In one implementation, the search terms can correspond to the word or phrase of the trending topic. In a variation, additional intelligence can be used to determine criterion that relate to the trending topic. For example, criteria determination component 120 can include programming, logic, and/or data structures (e.g., tables) to relate words or phrases corresponding to topical trends with additional search terms. For example, the criteria determination component 120 may determine search terms that reference a genus classification of the specific term or phrase that is identified as being a trending topic. For example, if the trending topic is “Tiger Woods”, the search terms can correspond to “golf”, “men's golf”, “the Masters” or other references that are relevant to Tiger Woods. As an alternative to determining a genus classification, the search terms can include terms that are known to be associated with a particular topic that is deemed trending. For example, “Tiger Woods” may be known to have an association with the term “Nike”, and a search criterion may correspond to “Tiger Woods”+“Nike”. In this manner, multiple search terms may be generated for a particular topical trend.

The search terms that are determined from the trending topic are used to perform one or more searches of a collection of content items (230). For example, the search component 130 may perform one or more search processes on one or more collections of content items. In an embodiment, a library of indexed web pages is searched using the determined search terms. Other collections of content items can be searched as well. For example, collections of content items that include media (e.g., video, images), user generated commentary, or other forms of content can be searched using the search terms.

A result of the search operations can be formatted and rendered for a particular user (240). In one embodiment, a webpage is pre-populated with portions of web pages that are identified as result of performing the search operation. The portions of the web pages can be populated with content resulting from the search operations (242). In variations, portions of the content items are distributed in panels that are arranged in a sequence, so as to be flipped, similar to the pages of a magazine. In another embodiment, the presentation can be provided as a feed that outputs portions of the content items resulting from the search processes (244). FIG. 3 illustrates an example of a presentation having panels that can provide access to content items, as feeds or links.

In an embodiment, one or more categories are determined from the content items resulting from searching using the terms determined from the topical trend. The presentation of the content items may be presented in a category specific median. Specifically, the webpage or panel can be dedicated to a category of the content items that result from performing the search operations using criteria determined from the topical trends.

According to embodiments, a process such as described by an embodiment of FIG. 2A may be implemented concurrently for multiple topical trends. The results of performing a method for each topical trend (e.g., content items identified from searching) can be made available to users of, for example, a system such as described with FIG. 1. When a user accesses a medium where category specific content items are provided or otherwise made accessible, the information determined from the user can be utilized to select categories that are to be provided to that user. For example, the selection of categories that are to be made available to the user may be based on a determined subject matter preference of the user, or a deemed geographic location of the user. The geographic location of the user may be based on, for example, the user's profile, user navigation input, and/or the user Internet Protocol (IP) address. As a variation, the categories of the content items for the different topical trends may be prioritized based on information that is deemed known about the user. For example, content items originating from search terms that relate to a category of interest of the user may be presented more prominently.

FIG. 2B illustrates a method for performing multiple search operations in connection with the identification of a particular topical trend, in order to determine category specific content that is trending in popularity or notoriety, under one or more embodiments. A method such as described with FIG. 2B may be implemented using a system such as described with an embodiment of FIG. 1. Accordingly, reference is made to elements of FIG. 1 for purpose of illustrating a suitable component for performing a step or sub-step being described.

In an embodiment, once a topical trend and relevant search terms are identified, search operations are performed to determine content items that are relevant to the topical trend. In an embodiment, the determined search terms (e.g., see 220 from FIG. 2A) are used to search a first source of content items (e.g., collection of web pages) (250). A search result is then obtained, which can correspond to, for example, links to web pages, as well as portions of the web pages that are identified (260).

From the results of the first search, alternative or additional search terms can be identified (270). For example, tags or other metadata accompanying web pages may be returned or made part of documents in the search result of the first search operation. A subsequent search operation is performed using search terms that are at last partially based on the tags or metadata that is returned with the first search operation (280). In some embodiments, the second or additional search can be performed on a source of content items that is different than the source of content items used for the first search. For example, the second search can be used to identify images or video, and performance of the search operation includes accessing a search service or interface for such types of content items.

A result of the first search and the second search can be combined (290). For example, content provided with content items appearing in each result may be provided at one time. As an example, the first search can be implemented to identify web pages, and the second search can be used to identify images or video. The results of the first search can be combined with the second search so that articles and images appear at one time, but which originate from different sources. Furthermore, the web pages and images can be determined from different search terms.

Presentation Example

FIG. 3 illustrates an example of a presentation for displaying content based on topical trends, according to one or more embodiments. An embodiment such as shown by FIG. 3 may be implemented through a system such as described by FIG. 1. Accordingly, reference is made to elements of FIG. 1 for purpose of illustrating a component or functionality that is suitable for implementing a panel such as described.

With reference to FIG. 3, a presentation 310 is an example of an output presentation 152 provided from the presentation component 150. In one implementation, presentation 310 includes multiple panels 320 that each includes a subject category designation. One or more of the panels 320 can be included as part of the presentation 310 based on a determination that the subject category correlates to a topic that is trending amongst a population of persons (e.g., potential users).

Accordingly, each panel 320 provides content items 322 that are deemed relevant to the particular category designation. The content items 322 can include text, images, or video. In the example shown, the individual content items 322 can include a link to a source, and/or a summary or portion of the content located by the link. In variations, the content items can include a rendering of a document or other file. For example, panel 320A may include content items 322 in the form of summary links (link with summary text of underlying content) and images. In variations, video or other forms of content can be previewed or otherwise provided through the panel 320.

The arrangement of panels 320 can vary. In one implementation, the panels 320 can be selected based on known or assumed preferences of a user for a particular subject category (e.g., “Golf”). As another variation or addition, the layout of the panels can be based on the user preference or other criterion (e.g., most popular category amongst population, category with most recent addition, etc.).

According to some embodiments, the content items 322 of a particular panel 320 are of a different type (e.g., text versus image or video). Furthermore, the content items 322 can be located by different search process. One set of content items can be aggregated using search criteria that is determined from topical trends. Another search process may be used to locate content of another type using search criteria determined from the result of the first search process.

According to an embodiment, multiple content items 322 can be provided sequentially or in sequenced form through the panel 320. For example, a first content item 322 can be selected or flipped to view a portion of a second content item that is not otherwise visible. Such format for displaying content items enables, for example, the feel of pagination, such as provided by a hard book or magazine.

As an alternative, other forms of presentations can be utilized. For example, rather than assign panels to subject categories, some embodiments provide for category-specific web pages which are pre-populated with content items. The pre-populated web pages may be selected based on topical trends. For example, a website may create or utilize subject specific web pages based on a determination that the subject matter is trending in popularity or relevance amongst a population.

According to an embodiment, the presentation 310 (or variations, such as described above) can be maintained in real-time based on identification of the hot subject categories. Thus, the presentation 310 may include panels 320 assigned to subject categories that are determined in real-time.

Additionally, once the subject categories are identified from the topical trends, the content items 322 that are made available through that panel can also be determined repeatedly in order to maintain the freshness of the content item that is available for display.

Computer System

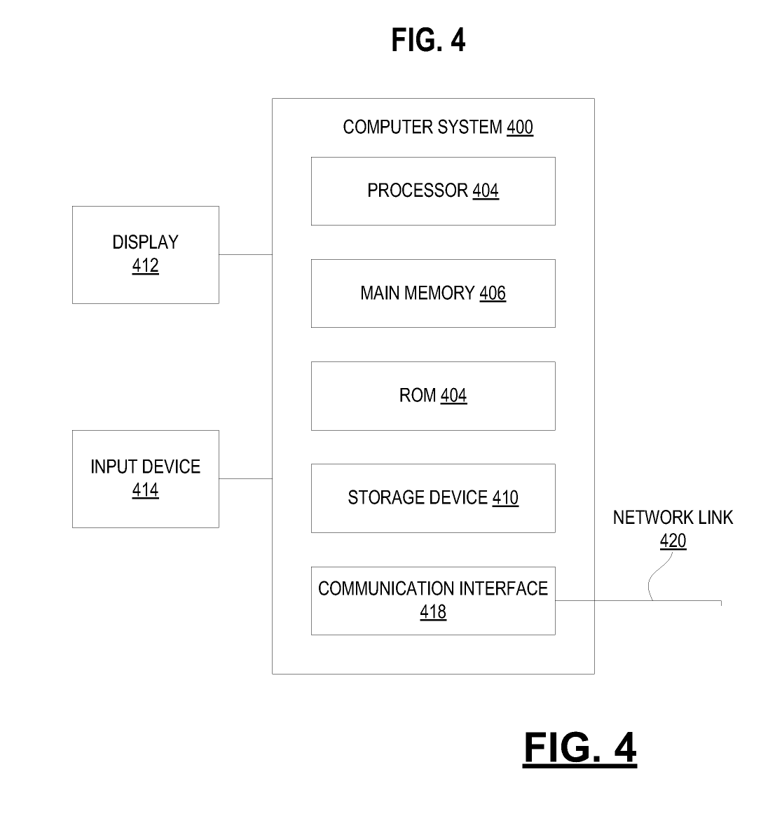

FIG. 4 is a block diagram that illustrates a computer system upon which embodiments described herein may be implemented. For example, in the context of FIG. 1, system 100 may be implemented using a computer system such as described by FIG. 4.

In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) 408 or other static storage device for storing static information and instructions for processor 404. A storage device 410, such as a magnetic disk or optical disk, is provided for storing information and instructions. The communication interface 418 may enable the computer system 400 to communicate with one or more networks through use of the network link 420 (wireless or wireline).

Computer system 400 can include display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments may include any number of input devices 414 coupled to computer system 400.

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A method for providing content, the method being implemented by one or more processors and comprising: using the one or more processors to perform steps comprising:
(a) identifying a plurality of topics that are trending based on communications originating from amongst a population of persons made over a period of time;
(b) determining one or more criteria for each of the plurality of topics;
(c) for each of the plurality of topics, determining a plurality of content items that satisfy the one or more criteria, and at least a subject category that is associated with the plurality of content items, by (i) performing a first search for a first plurality of content items from a first content source, (ii) performing a second search for a second plurality of content items from a second source different from the first source, and (iii) combining a first set of content items from the first plurality of content items with a second set of content items from the second plurality of content items, to form a third set of content items; and
(d) providing a medium that is specific to the subject category, to enable a user to access each of the plurality of third set of content items that are associated that subject category.

2. (canceled)

3. The method of claim 1, wherein the first set of content items are of a first type that is different than a second type of the second set of content items.

4. The method of claim 3, wherein the first type is a text-based document, and the second type is image and/or video.

5. The method of claim 1, wherein (c) includes determining the subject category based on a geography designation that is relevant to the user.

6. The method of claim 1, wherein (c) includes determining the subject category based on a profile preference of the user.

7. The method of claim 1, wherein (d) includes providing at least a portion of at least some of the third set of content items in a sequence.

8. The method of claim 1, wherein (d) includes providing a channel of content for the subject category.

9. The method of claim 1, wherein (d) includes providing at least a portion of a web page that is dedicated to the subject category.

10. The method of claim 1, wherein (a) includes retrieving data from a social network to determine the plurality of topics.

11. The method of claim 1, wherein (a) is performed at a plurality of instances, and wherein (c) is performed repeatedly in between each instance (a) is performed.

12. A system for providing content, the system comprising:
a memory;
one or more processors that communicate with the memory to receive instructions for implementing a plurality of components, including:
a criteria determination component to identify a criterion corresponding to a topic that is deemed to be trending, based on data provided from a social networking environment made over a period of time;
one or more search components that performs a first search for a first set of content items that satisfy the criterion, and a second search for a second set of content items, the second search being based on a set of tags that are provided with one or more content items in the first set of content items; and
a presentation component that identifies a subject category that is associated with at least some of the first set of content items and at least some of the second set of content items, the presentation component including a medium that is dedicated to the subject category and which includes content items provided from the at least some of the first set of content items and the second set of content items.

13. The system of claim 12, wherein the one or more search components perform the first search for text based articles, and the second search for media.

14. The system of claim 12, further comprising a filter to filter at least one of the first set of content items and the second set of content items based on a geography of a user that is to interact with an output of the presentation component.

15. The system of claim 12, further comprising a filter to filter at least one of the first set of content items and the second set of content items based on a preference of a user that is to interact with an output of the presentation component.

16. The system of claim 12, further comprising a social network interface that communicates with a social network in order to determine the topic that is tending in real-time.

17. The system of claim 12, wherein the presentation component provides at least a portion of at least some of the first set and the second set of content items in a sequence.

18. The system of claim 12, wherein the presentation component provides at least a channel of content for the subject category based on the at least some of the first set and the second set of content items.

19. The system of claim 12, wherein the presentation component provides at least a portion of a web page that is dedicated to the subject category.

20. A non-transitory computer readable medium that stores instructions for providing content, the instructions being implemented to cause one or more processors to perform operations comprising:
(a) identifying a plurality of topics that are trending based on communications originating from amongst a population of persons made over a period of time;
(b) determining one or more criteria for each of the plurality of topics;
(c) for each of the plurality of topics, determining a plurality of content items that satisfy the one or more criteria, and at least a subject category that is associated with the plurality of content items, by (i) performing a first search for a first plurality of content items from a first content source, (ii) performing a second search for a second plurality of content items from a second source different from the first source, and (iii) combining a first set of content items from the first plurality of content items with a second set of content items from the second plurality of content items, to form a third set of content items; and
(d) providing a medium that is specific to the subject category, to enable a user to access each of the third set of content items that are associated that subject category.
